(19) United States
(12) Patent Application Publication
(10) Pub. No.: US 2023/0070043 A1
(43) Pub. Date: Mar. 9, 2023

(54) METHOD FOR PERFORMING PRODUCT PROVIDING SERVICE, PRODUCT PROVIDING SERVER AND USER DEVICE

(71) Applicant: Hye Mi AHN, Seoul (KR)

(72) Inventor: Hye Mi AHN, Seoul (KR)

(73) Assignee: Hye Mi AHN, Seoul (KR)

(21) Appl. No.: 17/987,218

(22) Filed: Nov. 15, 2022

Related U.S. Application Data
(63) Continuation of application No. PCT/KR2021/006568, filed on May 27, 2021.

(30) Foreign Application Priority Data
May 29, 2020 (KR) 10-2020-0065220

(51) Int. Cl. G06Q 30/02; G06Q 30/06; G06Q 50/00

(52) U.S. Cl. CPC G06Q 30/0209; G06Q 30/06; G06Q 50/01

(57) ABSTRACT

A product providing method includes receiving a purchase request for a random box-type product from each of a plurality of user devices; proceeding with payment for the random box-type product purchased by each of the plurality of user devices; storing the random box-type products in inventories corresponding to each of the respective plurality of user devices; allowing the plurality of user devices to enter a chat room for opening the random box-type products stored in the inventories corresponding to each of the respective plurality of user devices together; opening the random box-type products stored in the inventories corresponding to each of the respective plurality of user devices; and providing a bonus item to at least some of the plurality of user devices based on the number of the plurality of user devices entering the chat room or a total price for the random box-type products.

### CROSS-REFERENCE TO RELATED APPLICATIONS

This application is a continuation of International Application No. PCT/KR2021/006568 filed on May 27, 2021, which claims priority to Korean Patent Application No. 10-2020-0065220 filed on May 29, 2020, the entire contents of which are herein incorporated by reference.

### TECHNICAL FIELD

The present disclosure relates to a method for performing a product providing service, a product providing server and a user device.

### BACKGROUND

Social commerce refers to e-commerce using social networks including social media and online/offline media. Social commerce can be classified into group buying type social commerce through which a certain number of people or more can buy products, social link-type social commerce that posts links to social networks, social web-type social commerce that combines consumers' activities, such as purchase, evaluation, review, and the like, in social networks, and offline linked-type social commerce that is extended and linked to offline spaces.

Recently, there has been provided a platform that enables a user to exchange a product purchased by another user with a product purchased through social commerce. In this regard, Korean Patent Laid-open Publication No. 2015-0013374, which is a prior art, discloses a social sharing platform system, a social sharing platform providing apparatus, a method for providing the same, a mobile communication device, and a social sharing platform service method thereof.

### SUMMARY

In view of the foregoing, the present disclosure provides a method for providing a product, a product providing server and a user device by which, when a purchase of a random box-type product is requested from a plurality of user devices, each of the plurality of user devices proceeds with payment for the purchased random box-type product and the paid random box-type product is stored in inventories corresponding to the respective plurality of user devices.

The present disclosure provides a method for providing a product, a product providing server and a user device by which a plurality of user devices is invited to a chat room for opening random box-type products stored in inventories corresponding to the respective plurality of user devices together and the random box-type products stored in the inventories corresponding to the respective plurality of user devices are opened.

The present disclosure provides a method for providing a product, a product providing server and a user device by which a bonus item is provided to at least some of a plurality of user devices entering a chat room based on the number of the plurality of user devices or a total price for random box-type products stored in inventories corresponding to the respective plurality of user devices.

However, the problems to be solved by the present disclosure are not limited to the above-described problems. There may be other problems to be solved by the present disclosure.

### Means for Solving the Problems

According to an aspect of the present disclosure, a product providing method for performing a product providing service by a product providing server includes receiving a purchase request for a random box-type product from a plurality of user devices, proceeding with payment for the random box-type product purchased by each of the plurality of user device, storing the random box-type products in inventories corresponding to each of the plurality of user devices, allowing the plurality of user devices to enter a chat room for opening the random box-type products stored in the inventories corresponding to each of the plurality of user devices together, opening the random box-type products stored in the inventories corresponding to each of the plurality of user devices, and providing a bonus item to at least some of the plurality of user devices based on the number of the plurality of user devices entering the chat room or a total price for the random box-type products stored in the inventories corresponding to each of the plurality of user devices.

According to another aspect of the present disclosure, a product providing server that performs a product providing service includes a request unit that receives a request for a purchase of a random box-type product from a plurality of user devices, a payment unit that proceeds with payment for the random box-type product purchased by each of the plurality of user devices, a storage unit that stores the random box-type products in inventories corresponding to each of the plurality of user devices, a chat room administration unit that allows the plurality of user devices to enter a chat room for opening the random box-type products stored in the inventories corresponding to each of the plurality of user devices together, a random box-type product opening unit that opens the random box-type products stored in the inventories corresponding to each of the plurality of user devices, and a bonus item providing unit that provides a bonus item to at least some of the plurality of user devices based on the number of the plurality of user devices entering the chat room or a total price for the random box-type products stored in the inventories corresponding to each of the plurality of user devices.

According to yet another aspect of the present disclosure, a product providing method for performing a product providing service in a user device includes requesting a purchase of a random box-type product to a product providing server, proceeding with payment for the requested random box-type product, transmitting, to the product providing server, a request for entry into a chat room for opening the random box-type product stored in an inventory corresponding to the user device together with a random box-type product stored in an inventory corresponding to at least one of other user devices when the payment for the random box-type product is completed, and receiving, from the product providing server, a result of opening the random box-type products stored in the inventories corresponding to the user device and at least one of the other user devices through the chat room. At least some of a plurality of user devices entering the chat room is provided with a bonus item based on a number of the plurality of user devices entering the chat room or a total price for the random box-type products stored in the inventories corresponding to each of the plurality of user devices

The above-described aspects are provided by way of illustration only and should not be construed as liming the present disclosure. Besides the above-described embodiments, there may be additional embodiments described in the accompanying drawings and the detailed description. According to any one of the above-described means for solving the problems of the present disclosure, it is possible to provide a method for providing a product, a product providing server and a user device by which a random box-type product can be opened together with other users through a chat room, and, thus, some fun is added to a random box-type product providing service.

Also, it is possible to provide a method for providing a product, a product providing server and a user device by which a plurality of user devices is invited to a chat room after purchasing a random box-type product, and, thus, a purchase of a random box-type product is induced.

Further, it is possible to provide a method for providing a product, a product providing server and a user device by which product information about a random box-type product can be checked through an open chat room with an unspecified number of people and a product providing service based on a random box-type product is provided for a meeting with a specific topic or purpose to socialize through a relevant chat room.

### BRIEF DESCRIPTION OF THE DRAWINGS

FIG. 1 is a diagram illustrating the configuration of a product providing service system in accordance with an embodiment of the present disclosure.

FIG. 2 is a diagram illustrating the configuration of a product providing server in accordance with an embodiment of the present disclosure.

FIG. 3A illustrates an example of bonus items provided through respective chat rooms in accordance with an embodiment of the present disclosure, and FIG. 3B illustrates an example of an administrator's rights assigned to the respective chat rooms in accordance with an embodiment of the present disclosure.

FIG. 4A is a diagram for describing a process in which a plurality of user devices enters a chat room by using random box-type products stored in inventories corresponding to the respective plurality of user devices in accordance with an embodiment of the present disclosure, and FIG. 4B is a diagram for describing a process in which a result of opening random box-type products selected by the plurality of user devices entering the chat room and a bonus item are acquired in accordance with an embodiment of the present disclosure.

FIG. 5 is a flowchart illustrating a method for performing a product providing service by a product providing server in accordance with an embodiment of the present disclosure.

FIG. 6 is a flowchart illustrating a method for performing a product providing service in a user device in accordance with an embodiment of the present disclosure.

### DETAILED DESCRIPTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “unit” includes a unit implemented by hardware, a unit implemented by software, and a unit implemented by both of them. One unit may be implemented by two or more pieces of hardware, and two or more units may be implemented by one piece of hardware.

Through the whole document, a part of an operation or function described as being carried out by a terminal or device may be carried out by a server connected to the terminal or device.

Likewise, a part of an operation or function described as being carried out by a server may be carried out by a terminal or device connected to the server.

Hereinafter, an embodiment of the present disclosure will be described in detail with reference to the accompanying drawings.

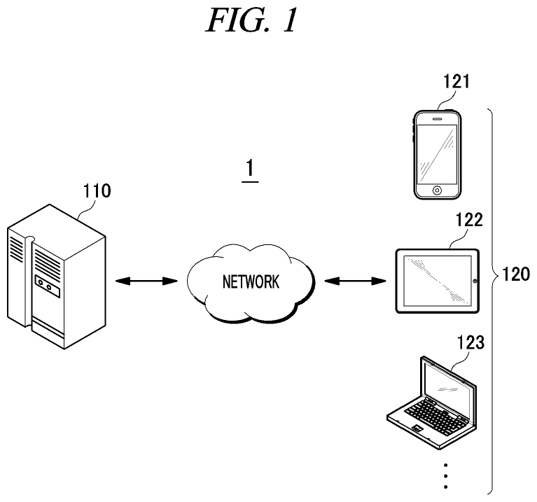

FIG. 1 is a diagram illustrating the configuration of a product providing service system in accordance with an embodiment of the present disclosure. Referring to FIG. 1, a product providing service system 1 may include a product providing server 110 and a user device 120. The product providing server 110 and the user device 120 illustrated in FIG. 1 are example components that can be controlled by the product providing service system 1.

The components of the product providing service system 1 illustrated in FIG. 1 are typically connected to each other via a network. For example, as illustrated in FIG. 1, a plurality of user devices 120 may be connected to the product providing server 110 simultaneously or sequentially.

The network refers to a connection structure that enables information exchange between nodes such as devices and servers. Examples of the network may include Wi-Fi, Bluetooth, Internet, LAN (Local Area Network), Wireless LAN (Wireless Local Area Network), WAN (Wide Area Network), PAN (Personal Area Network), 3G, 4G, 5G, LTE and the like, but are not limited thereto.

The product providing server 110 may receive a purchase request for a random box-type product from the plurality of user devices 120. Here, the random box-type product refers to a product from which a user does not know what item he/she will get. The user may acquire any of various items by purchasing the random box-type product. Here, any item to be acquired by the user may be randomly determined. Hereinafter, a description will be given on the assumption that the user device 120 purchases a random box-type product, but may also be applied to the case where the user device 120 purchases a general product.

The product providing server 110 may proceed with payment for the random box-type product purchased by each of the plurality of user devices 120. The product providing server 110 may determine at least one item to be provided to the user device 120 when the payment for the random box-type product is completed.

The product providing server 110 may store the random box-type products in inventories corresponding to the respective plurality of user devices 120.

The inventories will be briefly explained. The product providing server 110 may allocate the inventories to the respective plurality of user devices 120. For example, the product providing server 110 may create and allocate a first inventory corresponding to a first user device 121, a second inventory corresponding to a second user device 122, and a third inventory corresponding to a third user device 123.

The product providing server 110 may allow the plurality of user devices 120 to enter a chat room for opening the random box-type products stored in the inventories corresponding to the respective plurality of user devices 120 together. Here, the chat room may be operated according to a predetermined operation cycle based on the number of the plurality of user devices 120 which is able to enter the chat room and a price for a bonus item.

Since the chat room is operated according to the predetermined operation cycle based on the number of the plurality of user devices which is able to enter the chat room and the price for the bonus item, it is possible to make the users wait to join the chat room and anticipate a product providing service rather than a service which is available anytime.

The product providing server 110 may open the random box-type products stored in the inventories corresponding to the respective plurality of user devices 120. The product providing server 110 may determine items of the random box-type product to be opened and may expose information about the determined items. Here, the items are supplied by an advertiser and include, for example, goods, service vouchers, coupons and tokens, and a usage valid period may be set for some of the items.

The product providing server 110 receives any final random box-type product selected by each of the plurality of user devices 120 from among the random box-type products stored in the inventories corresponding to the respective plurality of user devices 120. When the selection of the final random box-type product is completed, the final random box-type product selected by each of the plurality of user devices 120 may be opened. Here, a result of opening the random box-type products stored in the inventories corresponding to the respective plurality of user devices 120 may be exposed to the plurality of user devices 120 entering the chat room.

The product providing server 110 may provide a bonus item to at least some of the plurality of user devices 120 based on the number of the plurality of user devices 120 entering the chat room or a total price for the random box-type products stored in the inventories corresponding to the respective plurality of user devices 120.

For example, the product providing server 110 may provide different bonus items to at least some of the plurality of user devices 120, respectively, when the number of the plurality of user devices 120 10, 100 and 1,000. For another example, the product providing server 110 may provide money or goods corresponding to 5% of the total price for the random box-type products stored in the inventories corresponding to the respective plurality of user devices 120 as a bonus item to at least some of the plurality of user devices 120.

In this case, the product providing server 110 may provide any one of a plurality of games to the plurality of user devices 120 entering the chat room. The games may include, for example, rock paper scissors, drawing lots, ghost leg, and the like.

The product providing server 110 may provide the bonus item to at least some of the plurality of user devices 120 based on a result of the provided game. Alternatively, the product providing server 110 may provide the bonus item to at least some of the plurality of user devices 120 by drawing lots.

The product providing server 110 may provide a chat interface that enables the plurality of user devices 120 to chat with each other through the chat room where the plurality of user devices 120 enters.

When the bonus item is completely provided, the product providing server 110 may simultaneously send off the plurality of user devices 120 entering the chat room.

The user device 120 may request a purchase of a random box-type product from the product providing server 110.

The user device 120 may proceed with payment for the requested random box-type product.

When the payment for the random box-type product is completed, the user device 120 may transmit, to the product providing server 110, a request for entry into a chat room for opening the random box-type product stored in an inventory corresponding to the user device 120 together with a random box-type product stored in an inventory corresponding to at least one of the other user devices.

The user device 120 may receive, from the product providing server 110, a result of opening the random box-type products stored in the respective inventories corresponding to the user device 120 and at least one of the other user devices through the chat room.

The user device 120 may include a wireless communication device 121 such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet), 3G, 4G and 5G devices and smart phone, and a tablet PC 122 such as a smart pad. In addition, the user device 120 may include all kinds of PCs 123 such as a desktop, a notebook, a netbook, a netbook, an ultrabook, a subnotebook, a desknote, a UMPC (Ultra-Mobile PC) and the like.

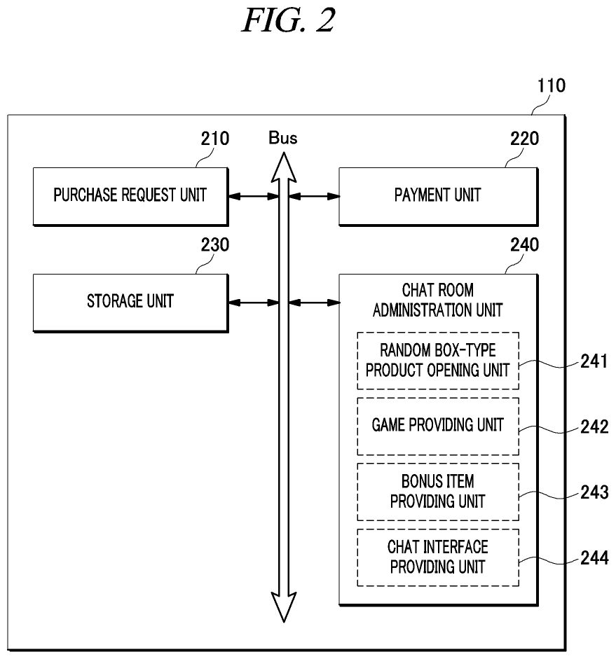

FIG. 2 is a diagram illustrating the configuration of a product providing server in accordance with an embodiment of the present disclosure. Referring to FIG. 2, the product providing server 110 may include a purchase request unit 210, a payment unit 220, a storage unit 230, and a chat room administration unit 240.

The purchase request unit 210 may receive a request for a purchase of a random box-type product from the plurality of user devices 120. Here, the random box-type product refers to a product from which a user does not know what item he/she will get. The user may acquire any of various items by purchasing the random box-type product. Here, any item to be acquired by the user may be randomly determined. Hereinafter, a description will be given on the assumption that the user device 120 purchases a random box-type product, but may also be applied to the case where the user device 120 purchases a general product.

The payment unit 220 may proceed with payment for the random box-type product purchased by each of the plurality of user devices 120. In this case, when the payment for the random box-type product is completed, at least one item to be provided to the user device 120 may be determined.

The storage unit 230 may store the random box-type products in inventories corresponding to the respective plurality of user devices 120.

The chat room administration unit 240 may allow the plurality of user devices 120 to enter a chat room for opening the random box-type products stored in the inventories corresponding to the respective plurality of user devices 120 together. For example, the chat room administration unit 240 may allow the plurality of user devices 120 to enter the chat room depending on the maximum number of chat room members based on whether or not the random box-type products have previously been stored in the inventories corresponding to the respective plurality of user devices 120.

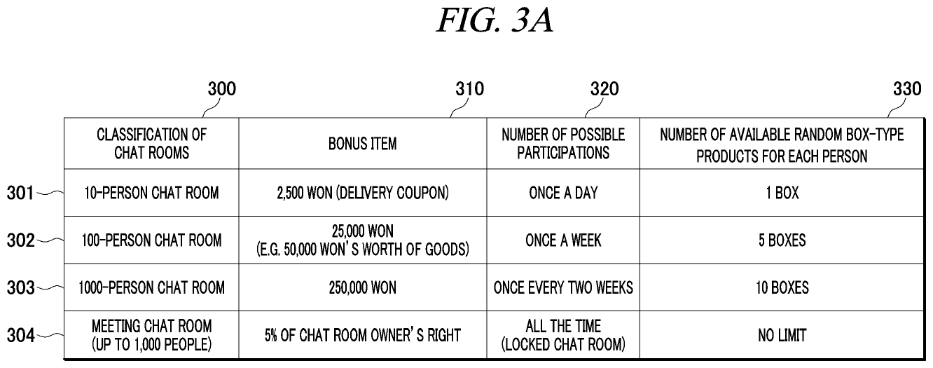

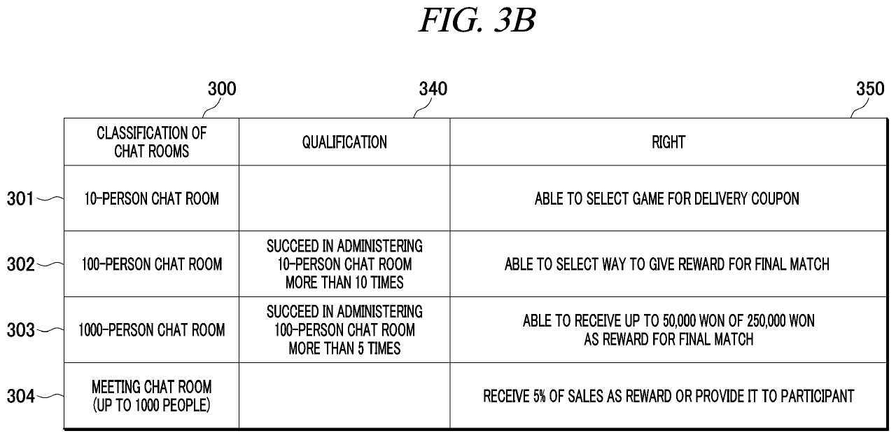

The chat room administration unit 240 may provide a bonus item to at least some of the plurality of user devices 120 entering the chat room. A process of providing a bonus item through a chat room will be described in detail with reference to FIG. 3A and FIG. 3B.

FIG. 3A illustrates an example of bonus items provided through respective chat rooms in accordance with an embodiment of the present disclosure, and FIG. 3B illustrates an example of an administrator's rights assigned to the respective chat rooms in accordance with an embodiment of the present disclosure.

Referring to FIG. 3A, if a chat room 300 may be composed of a 10-person chat room 301, a 100-person chat room 302, a 1,000-person chat room 303, and a meeting chat room 304, the chat room 300 may be operated according to a predetermined operation cycle based on the number of the plurality of user devices 120 which is able to enter the chat room and a price for the bonus item. The 10-person chat room 301 may be operated according to “bonus item 310: 2,500 won or delivery coupon”, “number of possible participations in chat room 320: once a day”, and “number of available random box-type products for each person 300: 1 box”. For example, the plurality of user devices 120 may enter the 10-person chat room 301 which is operated once a day by using up to “1 box” as a random box-type product. Here, the 10-person chat room 301 may be reset at 00:00.

The 100-person chat room 302 may be operated according to “bonus item 310: 25,000 won or 50,000 won's worth of goods supplied by advertiser”, “number of possible participations in chat room 320: once a week”, and “number of available random box-type products for each person 300: 5 boxes”. For example, the plurality of user devices 120 may enter the 100-person chat room 302 which is operated once a week by using up to “5 boxes” as random box-type products. Here, the 100-person chat room 302 may be reset at 00:00 on a specific day of each week (for example, on Tuesdays) or may be reset at dawn after a new item to be provided as a bonus item is registered.

The 1,000-person chat room 303 may be operated according to “bonus item 310: 25,000 won”, “number of possible participations in chat room 320: once every two weeks”, and “number of available random box-type products for each person 300: 10 boxes”. For example, the plurality of user devices 120 may enter the 1,000-person chat room 303 which is operated once every two weeks by using up to “10 boxes” as random box-type products. Here, the 1,000-person chat room 303 may be reset on the first and the fifteenth of every month.

The meeting chat room 304 may be operated according to “bonus item 310: 5% of chat room owner's right”, “number of possible participations in chat room 320: all the time (locked chat room)”, and “number of available random box-type products for each person 300: no limit”. Here, the meeting chat room 304 is created to support the activity of various meetings such as a Youtuber meeting, a club meeting, and the like, and a password may be set for socialization among participants or members of a specific meeting. Also, the number of possible participations in the chat room may not be limited.

Referring to FIG. 3B, if the chat room 300 is composed of the 10-person chat room 301, the 100-person chat room 302, the 1,000-person chat room 303, and the meeting chat room 304, an administrator (for example, an owner) of each chat room 300 may be assigned a different right. For example, an administrator of the chat room 300 may create a chat room and then, may set a chat room name to about 15 words and determine a way to give a reward through the chat room.

As for the 10-person chat room 301, all of the plurality of user devices 120 are assigned rights to administer the 10-person chat room 301, and the administrator of the 10-person chat room 301 may be given a right 350 to select a game. For example, the administrator of the 10-person chat room 301 may use the game-selecting right to select any one of a plurality of games for acquiring a bonus item.

As for the 100-person chat room 302, qualification 340 is granted to an administrator who succeeds in administering the 10-person chat room 301 more than 10 times among a plurality of administrators, and the administrator of the 100-person chat room 302 may be given a right 350 to select a way to give a reward for a final match of a game for acquiring a bonus item.

As for the 1,000-person chat room 303, the qualification 340 is granted to an administrator who succeeds in administering the 100-person chat room 302 more than 10 times among a plurality of administrators, and the administrator of the 1,000-person chat room 303 may be given the right 350 to receive up to 50,000 won of 250,000 won which is a reward for a final match of a game for acquiring a bonus item.

An administrator of the meeting chat room 304 may be given the right 350 to receive a reward corresponding to 5% of sales (for example, the total price of the random box-type products stored in the inventories corresponding to the respective plurality of user devices 120). Here, the rights of the administrator of the meeting chat room 304 are set in great detail, and the administrator may determine a reward and may acquire all of rewards and use them for events through personal broadcasting. Alternatively, the administrator of the meeting chat room 304 may be given the right 350 to provide a specific participant with a reward corresponding to 5% of sales. Referring back to FIG. 2, the chat room administration unit 240 may include a random box-type product opening unit 241, a game providing unit 242, a bonus item providing unit 243, and a chat interface providing unit 244.

The random box-type product opening unit 241 may open the random box-type products stored in the inventories corresponding to the respective plurality of user devices 120. Here, a result of opening the random box-type products stored in the inventories corresponding to the respective plurality of user devices 120 may be exposed to the plurality of user devices 120 entering the chat room.

For example, the random box-type product opening unit 241 may receive any final random box-type product selected for a predetermined period of time (for example, 10 seconds) by each of the plurality of user devices 120 from among the random box-type products stored in the inventories corresponding to the respective plurality of user devices 120. Here, when the selection of the final random box-type product is completed, the random box-type product opening unit 241 may open the final random box-type product selected by each of the plurality of user devices 120. To this end, if the chat room is crowded to capacity, a push notifying that “the chat room will be available in a minute” may be sent to the plurality of user devices 120 and each of the plurality of user devices 120 entering the chat room may select any final random box-type product by means of a timing game.

For another example, the random box-type product opening unit 241 may randomly grant each of the plurality of user devices 120 any final random box-type product among the random box-type products stored in the inventories corresponding to the respective plurality of user devices 120. Here, when the grant of the final random box-type product is completed, the random box-type product opening unit 241 may open the final random box-type product granted to each of the plurality of user devices 120.

The game providing unit 242 may provide any one of a plurality of games to the plurality of user devices 120 entering the chat room. The plurality of games may be games generating a random result, such as rock paper scissors, ghost leg, drawing lots, and the like.

The bonus item providing unit 24 may provide a bonus item to at least some of the plurality of user devices 120 based on the number of the plurality of user devices 120 entering the chat room or a total price for the random box-type products stored in the inventories corresponding to the respective plurality of user devices 120.

For example, the bonus item providing unit 243 may provide, as the bonus item, 2,500 won or a delivery coupon to at least some of the plurality of user devices 120 entering the 10-person chat room, 25,000 won or 50,000 won's worth of goods to at least some of the plurality of user devices 120 entering the 100-person chat room, and 250,000 won to at least some of the plurality of user devices 120 entering the 1,000-person chat room.

For another example, the bonus item providing unit 243 may provide at least some of the plurality of user devices 120 entering the meeting chat room with money corresponding to 5% of the total price for the random box-type products stored in the inventories corresponding to the respective plurality of user devices 120 or a bonus item equivalent thereto.

The bonus item providing unit 243 may provide the bonus item to at least some of the plurality of user devices 120 based on a result of the provided game. For example, the bonus item providing unit 243 may provide the bonus item to a user device for a game winner among the plurality of user devices 120.

Alternatively, the bonus item providing unit 243 may provide the bonus item to at least some of the plurality of user devices 120 by drawing lots.

The chat interface providing unit 244 may provide a chat interface that enables the plurality of user devices 120 to chat with each other through the chat room where the plurality of user devices 120 enters. Here, the plurality of user devices 120 entering the chat room may chat with each other for a predetermined period of time (for example, 2 minutes) through the chat interface. For example, the plurality of user devices 120 entering the chat room may chat with each other for about 1 minute after the chat room is crowded to capacity, for about 10 seconds while selecting a random box-type product, for about 10 seconds while the administrator of the chat room selects any one of a plurality of games, for about 10 seconds while playing the game and for about 30 seconds after the winner of the game is decided.

When the bonus item is completely provided, the chat room administration unit 240 may simultaneously send off the plurality of user devices 120 entering the chat room. For example, if the winner of the game is decided and then provided with the bonus item, the chat room administration unit 240 may automatically shut down the chat room 30 seconds later to simultaneously send off the plurality of user devices 120 entering the chat room.

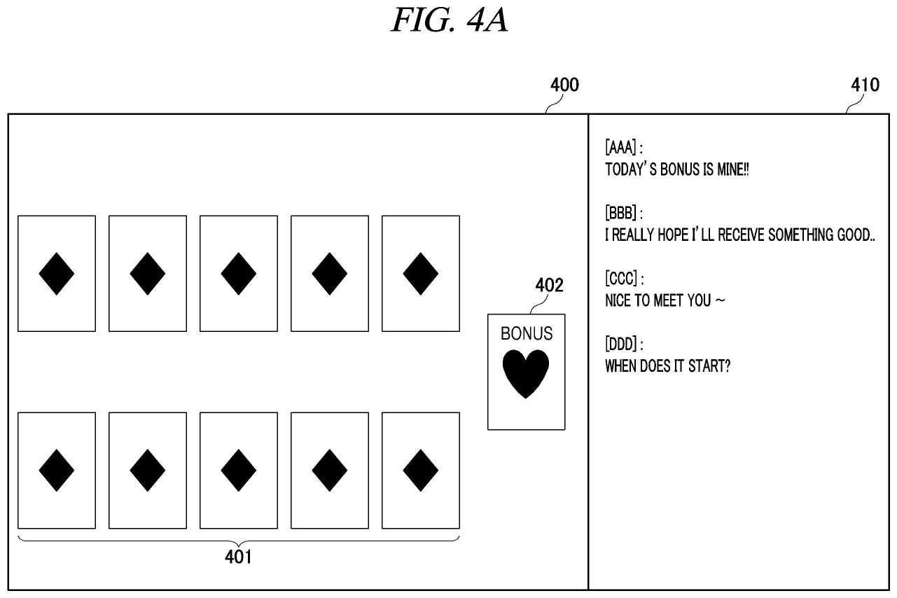

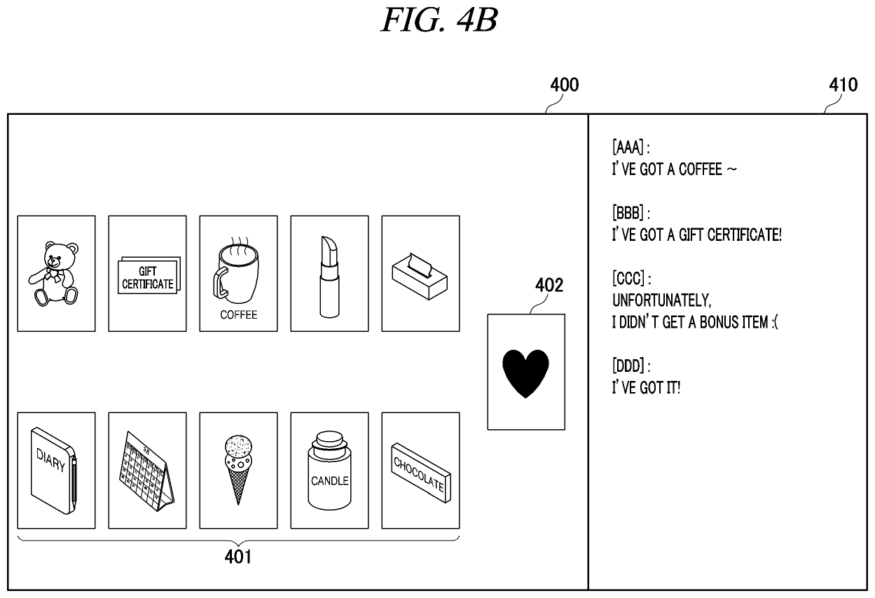

FIG. 4A is a diagram for describing a process in which a plurality of user devices enters a chat room by using random box-type products stored in inventories corresponding to the respective plurality of user devices in accordance with an embodiment of the present disclosure, and FIG. 4B is a diagram for describing a process in which a result of opening random box-type products selected by the plurality of user devices entering the chat room and a bonus item are acquired in accordance with an embodiment of the present disclosure.

According to an embodiment, the plurality of user devices 120 may enter a small-sized chat room (for example, 10-person chat room) and receive a product providing service.

FIG. 4A is a diagram for describing a process in which a plurality of user devices entering a chat room selects a random box-type product in accordance with an embodiment of the present disclosure. Referring to FIG. 4A, the plurality of user devices 120 may enter a chat room for opening random box-type products stored in inventories corresponding to the respective plurality of user devices 120 together. Here, each of the plurality of user devices 120 may enter the chat room by using random box-type products 401 stored in the inventories corresponding to the respective plurality of user devices 120 based on the maximum number (for example, 1) of the random box-type products 401 which is set depending on the size of a chat room.

The plurality of user devices 120 may display the random box-type products 401 stored in the inventories corresponding to the respective plurality of user devices 120 and a bonus item 402 in a first region 400 through the chat room.

For example, the plurality of user devices 120 may select the random box-type products 401 stored in the inventories corresponding to the respective user devices 120 and displayed in the first region 400. Here, each of the plurality of user devices 120 may select the random box-type product 401 within a predetermined period of time (for example, 10 seconds). If at least some of the plurality of user devices 120 selects the same random box-type product 401, the random box-type product 401 may be provided to a user device that selects the random box-type product 401 first in order of time, and a user device that does not select any random box-type product 401 within the predetermined period of time may be automatically provided with a remaining random box-type product 401.

The plurality of user devices 120 may display a chat window where a chat takes place among the plurality of user devices 120 in a second region 410. For example, the plurality of user devices 120 may chat with each other from when entering the chat room and while selecting the random box-type product 401 through the chat window displayed in the second region 410.

FIG. 4B is a diagram for describing a process in which a result of opening the random box-type products selected by the plurality of user devices entering the chat room and a bonus item are obtained in accordance with an embodiment of the present disclosure. Referring to FIG. 4B, when the selection of the random box-type products 401 is completed, the plurality of user devices 120 may receive a result of opening the random box-type products stored in the inventories corresponding to the respective plurality of user devices 120 from the product providing server 110 and display the same.

For example, the plurality of user devices 120 may display a result of opening the random box-type products 401, such as a doll, a mobile gift certificate, a coffee voucher, a lipstick, a box of tissues, a diary, a calendar, an ice cream cone, a candle, and a chocolate bar, through the first region 400 of the chat room, and may provide the same to the inventories of the plurality of user devices 120 that selects the random box-type products 401.

Then, the plurality of user devices 120 may play a game for acquiring the bonus game 402 through a separate pop-up window displayed in the first region 410. Here, the game may be any one selected by the administrator of the chat room from among a plurality of games. The plurality of games may be games generating a random result, such as rock paper scissors, ghost leg, drawing lots, and the like.

For example, when the plurality of user devices 120 plays a game, the bonus item 402 may be provided to the winner of the game according to a result of the game. Here, the bonus item 402 may correspond to 5% of a total price for the random box-type products opened in the small-sized chat room, such as 2,500 won or a delivery coupon.

The plurality of user devices 120 may chat with each other through the chat window displayed in the second region 410 while the administrator selects one of the plurality of games, while the game is played and until the chat room is shut down after the winner of the game is decided.

In this way, the plurality of user devices 120 may enter a small-sized chat room (for example, 10-person chat room) created every day and acquire the random box-type product 401 and the bonus item 402.

According to another embodiment, the winner of the game of the small-sized chat room may enter a medium-sized chat room (for example, 100-person chat room) created once a week and may be provided with a product providing service. In the medium-sized chat room, the product providing service may be provided through a tournament including main matches and a final match. Each of the plurality of user devices 120 entering the medium-sized chat room may enter a chat room by using random box-type products stored in the inventories corresponding to the respective plurality of user devices 120 based on the maximum number (for example, 5) of the random box-type products which is set depending on the size of the chat room.

For example, the plurality of user devices 120 entering the medium-sized chat room may acquire random box-type products through main matches in the same way as in the small-sized chat room. Here, the main matches are played in a plurality of sub-chat rooms (for example, ten 10-person chat rooms) such as small-sized chat rooms or may be played in a single medium-sized chat room, but the present disclosure is not limited thereto.

Each of the plurality of user devices 120 participating in the plurality of sub-chat rooms may play games for a place in the final match. Here, the winner of the game in each of the plurality of sub-chat rooms may acquire a place in the final match.

Then, a user device that acquires a place in the final match among the plurality of user devices 120 may play a final game for acquiring a bonus item. The bonus item for the medium-sized chat room may correspond to 5% of a total price for the random box-type products for the medium-sized chat room, such as 25,000 won or 50,000 won's worth of goods.

The plurality of user devices 120 entering the medium-sized chat room may watch all of the main matches played in the plurality of sub-chat rooms and the final match played in the medium-sized chat room.

According to yet another embodiment, the winner of the game played in the medium-sized chat room may enter a large-sized chat room (for example, 100-person chat room) created once every two weeks and may be provided with a product providing service. In the large-sized chat room, the product providing service may be provided through a tournament including main matches, semi-final matches and a final match. Each of the plurality of user devices 120 may enter a chat room by using random box-type products stored in the inventories corresponding to the respective plurality of user devices 120 based on the maximum number (for example, 10) of the random box-type products 401 which is set depending on the size of the chat room.

For example, the plurality of user devices 120 entering the large-sized chat room may acquire random box-type products through main matches in the same way as in the small-sized chat room. Here, the main matches are played in a plurality of first sub-chat rooms (for example, one hundred 10-person chat rooms) such as small-sized chat rooms or may be played in a single large-sized chat room, but the present disclosure is not limited thereto.

Each of the plurality of user devices 120 participating in the plurality of first sub-chat rooms may play games for a place in the semi-final matches. Here, the winner of the game in each of the plurality of first sub-chat rooms may acquire a place in the semi-final matches.

Thereafter, the semi-final matches are played in second sub-chat rooms (for example, ten 10-person chat room), and a user device that acquires a place in the semi-final matches among the plurality of user devices 120 may play a game for a place in the final match in the plurality of second sub-chat rooms (for example, ten 10-person chat room).

Then, a user device that acquires a place in the final match among the plurality of user devices 120 may play a final game for acquiring a bonus item. The bonus item for the large-sized chat room may correspond to 5% of a total price for the random box-type products for the large-sized chat room, such as 250,000 won.

The plurality of user devices 120 entering the large-sized chat room may watch all of the main and semi-final matches played in the plurality of first and second sub-chat rooms and the final match played in the large-sized chat room.

According to still another embodiment, the plurality of user devices 120 may enter a meeting chat room with a specific topic or purpose and may be provided with a product providing service. Here, the plurality of user devices 120 entering the meeting chat room may acquire random box-type products in the same way as in the small-sized chat room.

Also, the plurality of user devices 120 entering the meeting chat room may play a game for a bonus item. Here, the winner of the game may be provided with 5% of a total price for the random box-type products for the meeting chat room as the bonus item for the meeting chat room. Alternatively, the administrator may acquire 5% of sales and use it for events.

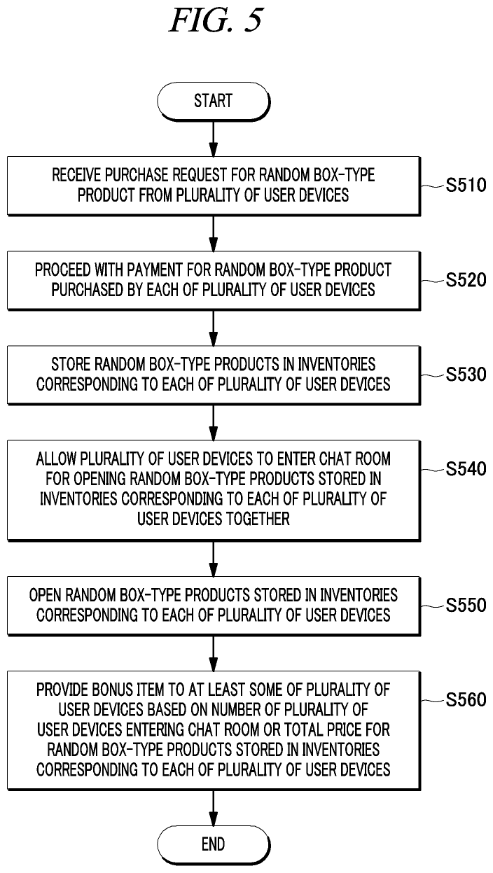

FIG. 5 is a flowchart illustrating a method for performing a product providing service by a product providing server in accordance with an embodiment of the present disclosure. The method for providing a product providing service by the product providing server 110 according to the embodiment illustrated in FIG. 5 includes the processes time-sequentially performed by the product providing service system 1 according to the embodiment illustrated in FIG. 1 to FIG. 4D. Therefore, descriptions of the processes performed by the product providing service system 1 may be applied to the method of providing a product providing service by the product providing server 110 according to the embodiment illustrated in FIG. 1 to FIG. 4D, even though they are omitted hereinafter.

In a process 5510, the product providing server 110 may receive a purchase request for a random box-type product from the plurality of user devices 120.

In a process 5520, the product providing server 110 may proceed with payment for the random box-type product purchased by each of the plurality of user devices 120.

In a process 5530, the product providing server 110 may store the random box-type products in inventories corresponding to the respective plurality of user devices 120.

In a process 5540, the product providing server 110 may allow the plurality of user devices 120 to enter a chat room for opening the random box-type products stored in the inventories corresponding to the respective plurality of user devices 120 together.

In a process 5550, the product providing server 110 may open the random box-type products stored in the inventories corresponding to the respective plurality of user devices 120.

In a process 5560, the product providing server 110 may provide a bonus item to at least some of the plurality of user devices 120 based on the number of the plurality of user devices 120 entering the chat room or a total price for the random box-type products stored in the inventories corresponding to the respective plurality of user devices 120.

In the descriptions above, the processes 5510 to 5560 may be divided into additional processes or combined into fewer processes depending on an embodiment. In addition, some of the processes may be omitted and the sequence of the processes may be changed if necessary.

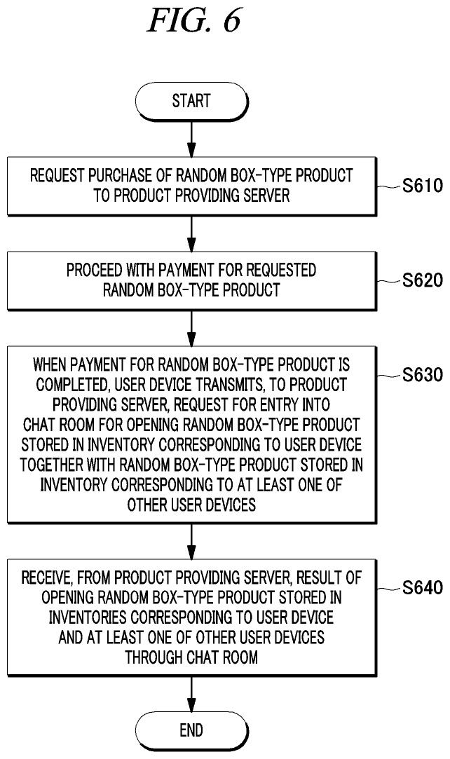

FIG. 6 is a flowchart illustrating a method for performing a product providing service in a user device in accordance with an embodiment of the present disclosure. The method for performing a product providing service in the user device 120 according to the embodiment illustrated in FIG. 6 includes the processes time-sequentially performed by the product providing service system 1 according to the embodiment illustrated in FIG. 1 to FIG. 5. Therefore, descriptions of the processes performed by the product providing service system 1 may be applied to the method of performing a product providing service in the user device 120 according to the embodiment illustrated in FIG. 1 to FIG. 5, even though they are omitted hereinafter.

In a process 5610, the user device 120 may request a purchase of a random box-type product from the product providing server 110.

In a process 5620, the user device 120 may proceed with payment for the requested random box-type product.

In a process 5630, when the payment for the random box-type product is completed, the user device 120 may transmit, to the product providing server 110, a request for entry into a chat room for opening the random box-type product stored in an inventory corresponding to the user device 120 together with a random box-type product stored in an inventory corresponding to at least one of the other user devices.

In a process 5640, the user device 120 may receive, from the product providing server 110, a result of opening the random box-type products stored in the respective inventories corresponding to the user device 120 and at least one of the other user devices through the chat room.

In the descriptions above, the processes 5610 to 5640 may be divided into additional processes or combined into fewer processes depending on an embodiment. In addition, some of the processes may be omitted and the sequence of the processes may be changed if necessary.

The product providing method for providing the product providing service by the product providing server and the user device as described above with reference to FIG. 1 to FIG. 6 can be implemented as a computer program stored in a medium to be executed by a computer or a storage medium including instructions executable by a computer. Also, the product providing method for providing the product providing service by the product providing server and the user device as described above with reference to FIG. 1 to FIG. 6 can be implemented as a computer program stored in a medium to be executed by a computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A product providing method for performing a product providing service by a product providing server, comprising:
receiving a purchase request for a random box-type product from a plurality of user devices;
proceeding with payment for the random box-type product purchased by each of the plurality of user devices;
storing the random box-type products in inventories corresponding to each of the plurality of user devices;
allowing the plurality of user devices to enter a chat room for opening the random box-type products stored in the inventories corresponding to each of the plurality of user devices together;
opening the random box-type products stored in the inventories corresponding to each of the plurality of user devices; and
providing a bonus item to at least some of the plurality of user devices based on a number of the plurality of user devices entering the chat room or a total price for the random box-type products stored in the inventories corresponding to each of the plurality of user devices.

2. The product providing method of claim 1,
wherein a result of opening the random box-type products stored in the inventories corresponding to each of the plurality of user devices is exposed to the plurality of user devices entering the chat room.

3. The product providing method of claim 1, further comprising:
providing a chat interface that enables the plurality of user devices to chat with each other through the chat room where the plurality of user devices enter.

4. The product providing method of claim 1,
wherein the opening the random box-type products includes:
receiving any final random box-type product selected by each of the plurality of user devices from among the random box-type products stored in the inventories corresponding to the respective plurality of user devices; and
opening the final random box-type product selected by each of the plurality of user devices when the selection of the final random box-type product is completed.

5. The product providing method of claim 1,
wherein the providing the bonus item to at least some of the plurality of user devices includes:
providing the bonus item to at least some of the plurality of user devices by drawing lots.

6. The product providing method of claim 1, further comprising:
wherein the providing the bonus item to at least some of the plurality of user devices includes:
providing any one of a plurality of games to the plurality of user devices entering the chat room; and
providing the bonus item to at least some of the plurality of user devices based on a result of the provided game.

7. The product providing method of claim 6, further comprising:
simultaneously sending off the plurality of user devices entering the chat room when the bonus item is completely provided.

8. The product providing method of claim 1,
wherein the chat room is operated according to a predetermined operation cycle based on a number of the plurality of user devices which is able to enter the chat room and a price for the bonus item.

9. A product providing server that performs a product providing service, comprising:
a request unit that receives a request for a purchase of a random box-type product from a plurality of user devices;
a payment unit that proceeds with payment for the random box-type product purchased by each of the plurality of user devices;
a storage unit that stores the random box-type products in inventories corresponding to each of the plurality of user devices;
a chat room administration unit that allows the plurality of user devices to enter a chat room for opening the random box-type products stored in the inventories corresponding to each of the plurality of user devices together;
a random box-type product opening unit that opens the random box-type products stored in the inventories corresponding to each of the plurality of user devices; and
a bonus item providing unit that provides a bonus item to at least some of the plurality of user devices based on a number of the plurality of user devices entering the chat room or a total price for the random box-type products stored in the inventories corresponding to each of the plurality of user devices.

10. The product providing server of claim 9,
wherein a result of opening the random box-type products stored in the inventories corresponding to each of the plurality of user devices is exposed to the plurality of user devices entering the chat room.

11. The product providing server of claim 9, further comprising:
a chat interface providing unit that provides a chat interface that enables the plurality of user devices to chat with each other through the chat room where the plurality of user devices enter.

12. The product providing server of claim 9,
wherein the random box-type product opening unit receives any final random box-type product selected by each of the plurality of user devices from among the random box-type products stored in the inventories corresponding to the respective plurality of user devices, and opens the final random box-type product selected by each of the plurality of user devices when the selection of the final random box-type product is completed.

13. The product providing server of claim 9,
wherein the bonus item providing unit provides the bonus item to at least some of the plurality of user devices by drawing lots.

14. The product providing server of claim 9, further comprising:
a game providing unit that provides any one of a plurality of games to the plurality of user devices entering the chat room,
wherein the bonus item providing unit provides the bonus item to at least some of the plurality of user devices based on a result of the provided game.

15. The product providing server of claim 14,
wherein the chat room administration unit simultaneously sends off the plurality of user devices entering the chat room when the bonus item is completely provided.

16. The product providing server of claim 9,
wherein the chat room is operated according to a predetermined operation cycle based on a number of the plurality of user devices which is able to enter the chat room and a price for the bonus item.

17. A product providing method for performing a product providing service in a user device, comprising:
requesting a purchase of a random box-type product to a product providing server;
proceeding with payment for the requested random box-type product;
transmitting, to the product providing server, a request for entry into a chat room for opening the random box-type product stored in an inventory corresponding to the user device together with a random box-type product stored in an inventory corresponding to at least one of other user devices when the payment for the random box-type product is completed; and
receiving, from the product providing server, a result of opening the random box-type products stored in the inventories corresponding to the user device and at least one of the other user devices through the chat room,
wherein at least some of a plurality of user devices entering the chat room is provided with a bonus item based on a number of the plurality of user devices entering the chat room or a total price for the random box-type products stored in the inventories corresponding to each of the plurality of user devices.
